(19) United States
(12) Patent Application Publication
(10) Pub. No.: US 2011/0142482 A1
(43) Pub. Date: Jun. 16, 2011

(54) SHEET FEEDING DEVICE AND IMAGE FORMING APPARATUS

(76) Inventor: Akira NAKASHIMA, Osaka-shi (JP)

(21) Appl. No.: 12/963,955

(22) Filed: Dec. 9, 2010

(30) Foreign Application Priority Data
Dec. 10, 2009 (JP) 2009-280375

(51) Int. Cl. G03G 21/20

(52) U.S. Cl. 399/93; 399/361

(57) ABSTRACT

A sheet feeding device includes a sheet tray, a main body, an ion generating device, a first duct, a second duct, and a fan. The main body is designed to accommodate therein the sheet tray in a state capable of being drawn out toward the front. The ion generating device is disposed on a rear side of the sheet tray in the main body and has an ion generating function. The first and second ducts are disposed in such a manner as to cover the ion generating device and are designed to define a flow path for guiding air taken therein from outside the main body to outside the main body again.

### CROSS REFERENCE

This Nonprovisional application claims priority under 35 U.S.C. §119(a) on Patent Application No. 2009-280375 filed in Japan on Dec. 10, 2009, the entire contents of which are hereby incorporated by reference.

### BACKGROUND OF THE INVENTION

The present invention relates to a sheet feeding device having an ion generating function, and an image forming apparatus incorporating the same.

It is no exaggeration to say that image forming apparatuses, such as a copier and a printer, are indispensable for offices and the like. Actually, offices are mostly installed with image forming apparatuses. Further, such image forming apparatuses have recently become familiar to us because they are spreading even to standard homes, hospitals and the like.

Among known image forming apparatuses, there are apparatuses of the type configured to supply the image forming section and fixing section thereof with air taken into the housing from around the image forming apparatus and then exhaust the air out of the image forming apparatus. One such image forming apparatus is provided with an air cleaning section configured to prevent harmful substances produced within the apparatus from being discharged out of the apparatus by eliminating harmful substances contained in a flow of air to be exhausted out of the apparatus to clean the air and then supplying negative ions to the air (see Japanese Patent Laid-Open publication No. 2005-4144 for example).

According to the technique described in Japanese Patent Laid-Open publication No. 2005-4144 noted above, it is necessary to eliminate toner particles, dust, ozone and the like produced by the image forming operation of the image forming section and, hence, an ion generating section having electrodes has to be unavoidably disposed at a location adjacent the image forming section and inside the air flow generated around the image forming section. As a result, a problem sometimes occurs that the ion generating efficiency of the ion generating section lowers earlier than expected due to the effect of silicon and the like produced around the image forming apparatus. Therefore, the above-described technique has a problem that the ability to clean air around the image forming apparatus lowers as the duration of use of the image forming apparatus becomes longer.

In cases where a unit having the air cleaning function is positioned outside the image forming apparatus in order to provide a larger distance between the ion generating section and the image forming section, an additional space is necessary for installation of such a unit, which results in a problem that an enlarged space is needed for installation of the image forming apparatus.

A feature of the present invention is to provide a sheet feeding device and an image forming apparatus which are capable of performing the function of generating ions stably over a long time period without capsizing of the device and the apparatus.

### SUMMARY OF THE INVENTION

A sheet feeding device according to the present invention has an ion generating function. Exemplary structures of the to sheet feeding device include a structure incorporated integrally in a housing of a processing apparatus such as an image forming apparatus, and a structure as an optional external device to be connected to the housing of the processing apparatus.

The sheet feeding device includes a sheet tray, a main body, an ion generating device, a duct portion, and a fan. The sheet tray is designed to store recording sheets therein. The main body designed to accommodate therein the sheet tray in a state capable of being drawn out.

The ion generating device is disposed on a rear side of the sheet tray in the main body and has an ion generating function. The duct portion is disposed in such a manner as to cover the ion generating device and is designed to define a flow path for guiding air taken therein from outside the main body to the outside the main body again. The fan is designed to generate an air flow within the duct portion.

In this construction, the ion generating device disposed within the sheet feeding device is located inside the duct having opposite ends in communication with the outside of the housing. Therefore, the ion generating device is positioned in a space isolated from the space to which the image forming section in the housing of the image forming apparatus belongs, thereby being kept from the effect of silicon and the like produced from the image forming section.

Further, the ion generating device is disposed in the main body by effectively utilizing a free space on the rear side of the sheet tray. Therefore, the ion generating device, duct and the like fail to project outwardly of the main body of the sheet feeding device and, as a result, there is no need to enlarge the space required for installation of the sheet feeding device and the image forming apparatus even when the ion generating device is provided.

The present invention makes it possible to impart the sheet feeding device and the image forming apparatus with the function of generating ions stably over a long time period while preventing the device and the apparatus from being upsized.

The foregoing and other features and attendant advantages of the present invention will become more apparent from the reading of the following detailed description of the invention in conjunction with the accompanying drawings.

### BRIEF DESCRIPTION OF THE DRAWINGS

FIG. 1A is a perspective view, as viewed from the front side, of a copier according to an embodiment of the present invention;

FIG. 1B is a perspective view, as viewed from the rear side, of the copier according to the embodiment of the present invention;

FIG. 2 is a sectional view schematically illustrating the copier according to the embodiment of the present invention;

FIG. 3A is a view illustrating a state in which a sheet tray is drawn from a copier body;

FIG. 3B is a perspective view schematically illustrating an exemplary structure of a sheet feeding device;

FIG. 4 is a view schematically illustrating an exemplary structure of the sheet feeding device;

FIG. 5 is a view illustrating the position of the sheet feeding device in the copier;

FIG. 6A is a perspective view illustrating a structural variation of the sheet feeding device;

FIG. 6B is a sectional plan view of the sheet feeding device shown in FIG. 6A;

FIG. 7A is a sectional plan view illustrating another structural variation of the sheet feeding device;

FIG. 7B is a perspective view illustrating an exemplary copier provided with the sheet feeding device shown in FIG. 7A;

FIG. 7C is a perspective view illustrating another exemplary copier provided with the sheet feeding device shown in FIG. 7A;

FIG. 8 is a view illustrating a structural variation of the sheet feeding device;

FIG. 9A is a sectional plan view illustrating yet another structural variation of the sheet feeding device;

FIG. 9B is a perspective view illustrating an exemplary copier provided with the sheet feeding device shown in FIG. 9A; and

FIG. 9C is a perspective view illustrating another exemplary copier provided with the sheet feeding device shown in FIG. 9A.

### DETAILED DESCRIPTION OF THE INVENTION

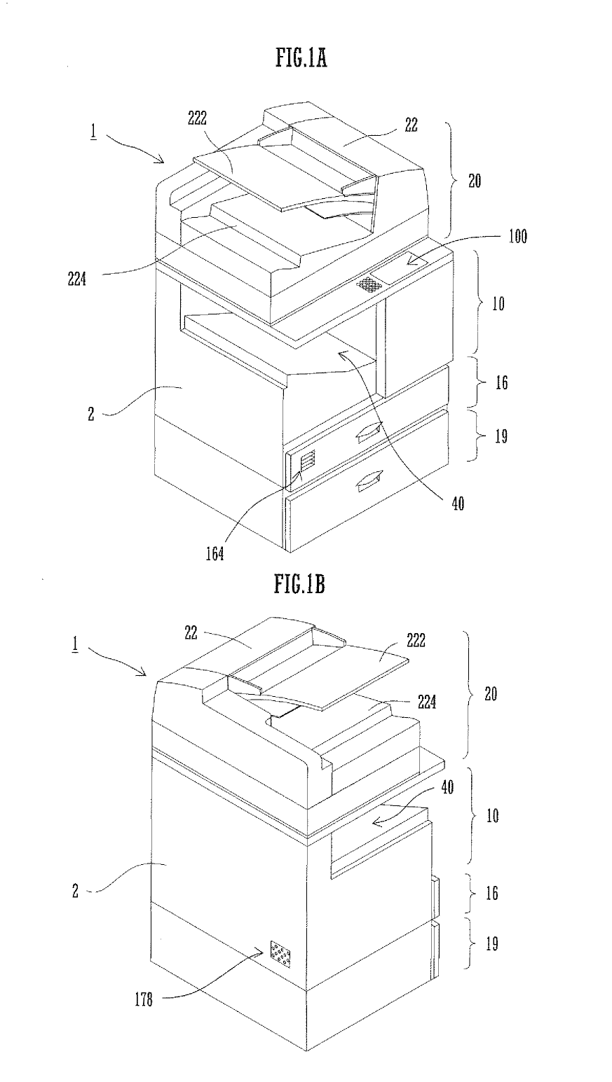

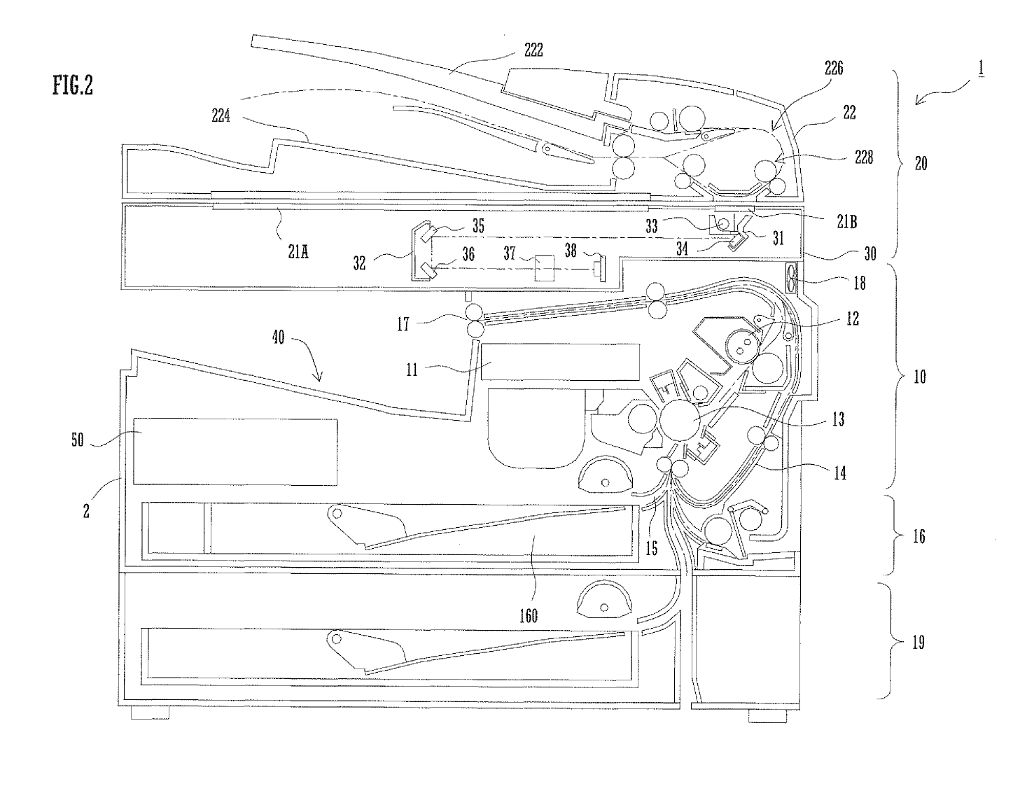

Referring to FIGS. 1A, 1B and 2, description will be made of the construction of a copier 1 according to an embodiment of the present invention. As shown in these figures, the copier 1 includes a document reading section 20, an image forming section 10, a first sheet feeding device 16, and a second sheet feeding device 19. As shown in FIG. 1A, the copier 1 further includes an operating panel 100 on the front side thereof for receiving input operations from the user.

As shown in FIG. 2, the document reading section 20 includes document platens 21A and 21B each formed of transparent glass, a scanner unit 30 configured to read an image from a document placed on the document platen 21A or 21B, and an automatic document feeder 22 for automatically feeding document sheets onto the document platen 21B. The document platen 21A is used for document reading in a document fixing mode, while the document platen 21B used for document reading in a document feeding mode using the automatic document feeder 22.

The automatic document feeder 22 includes a document tray 222 for placing thereon a document to be read, a document delivery tray 224 for receiving a document having been read, and a document feed path 226 formed to guide a document from the document tray 222 up to the document delivery tray 224 via a document reading position (the position of the document platen 21B according to the present embodiment). The document feed path 226 is provided with a plurality of feed rollers 228 arranged to apply a feeding force onto the document in the document feed path 226.

The automatic document feeder 22 automatically feeds plural document sheets set on the document tray 222 onto the document platen 212 one by one through the document feed path 226. The document sheets having been finished with reading at the document platen 212 are delivered onto the document delivery tray 224.

For the scanner unit 30 to read images on both sides of a document according to selection by the user, the automatic document feeder 22 is provided with a feed path for double-sided documents, feed path switching means, a group of sensors for detecting and controlling the states of document sheets passing through different sections, and the like. These components are not essential requirements for carrying out the present invention, but are optional elements.

The scanner unit 30 includes a first scanning unit 31, a second scanning unit 32, an optical lens 37, and a photoelectric converter (hereinafter will be referred to as “CCD”) 38. The first scanning unit 31 has a lamp reflector assembly 33 for exposing a document surface to light and a first reflecting mirror 34 for guiding a light image reflected from a document to the CCD 38. The second scanning unit 32 has second and third reflecting mirrors 35 and 36 for guiding the light image from the first scanning unit 31 to the CCD 38. The optical lens 37 directs the light image reflected from the document toward the CCD 38 to form an image on the CCD 38. The CCD 38 converts the light image reflected from the document to an electrical image signal.

The above-described arrangement of the document reading section 20 enables the image on the document placed on the document platen 21A to be read by forming the image on the CCD 38 on a line-by-line basis. The image data read by the scanner unit 30 is transmitted to a non-illustrated image processing section where the image data is subjected to various image processing operations, temporarily stored in a storage section of the copier 1, and then transferred to the image forming section 10 in response to an output instruction.

The image forming section 10 has a housing 2. Within the housing 2 a sheet feed path is formed to extend from the first sheet feeding device 16 storing therein recording sheets to be subjected to an image forming process to a sheet delivery roller 17 configured to deliver recording sheets to a sheet delivery section 40 of an in-body delivery type (configured to deliver recording sheets to a place inside the body of the copier 1), via the image forming position. The image forming section 10 is provided with a sheet feeding system, a laser writing unit 11, and an electrophotographic processing section 13 for image formation which are arranged along the sheet feed path.

The laser writing unit 11 includes a semiconductor laser light source configured to emit laser light according to image data transferred from the aforementioned document reading section 20 or transmitted from external equipment such as a personal computer, a polygonal mirror configured to deflect the laser light at equal angular velocity, an f-θ lens for correcting the laser light thus deflected at equal angular velocity so that a photosensitive drum in the electrophotographic section 13 is scanned with the laser light at equal velocity.

The electrophotographic processing section 13 includes, around the photosensitive drum as an image carrier, an electrostatic charger for electrostatically charging the photosensitive drum uniformly, a developing device for supplying developer onto an electrostatic latent image formed on the photosensitive drum by the laser writing unit 11, a transfer device for transferring the resulting developer image from the photosensitive drum to a recording sheet, a separation device for separating the recording sheet from the photosensitive drum, a cleaning device for removing residual developer from the photosensitive drum, and a static eliminator for eliminating static charges from the surface of the photosensitive drum.

At a location on the sheet feed path upstream of the electrophotographic processing section 13, there is disposed a feeding section 15 for feeding a recording sheet stored in the first sheet feeding device 16 or the second sheet feeding device 19 to a transfer position between the photosensitive drum and the transfer device in the electrophotographic processing section 13. At a location on the sheet feed path downstream of the electrophotographic processing section 13, there is disposed a fixing device 12 for fixing the developer image in a state of being attached to but unfixed to the recording sheet onto the recording sheet by heat and pressure. Further, a re-feed path is disposed downstream of the fixing device 12 for re-feeding a recording sheet having been subjected to fixing on the obverse side thereof in order to form an image on the reverse side thereof. An exhaust fan 18 is disposed adjacent the fixing device 12 for exhausting gas produced around the electrophotographic processing section 13 and fixing device 12 out of the copier 1.

The copier 1 has a power source unit 50 disposed above the first sheet feeding device 16 and below the sheet delivery section 40. The power source unit 50 is configured to supply electric power to different sections of the copier 1.

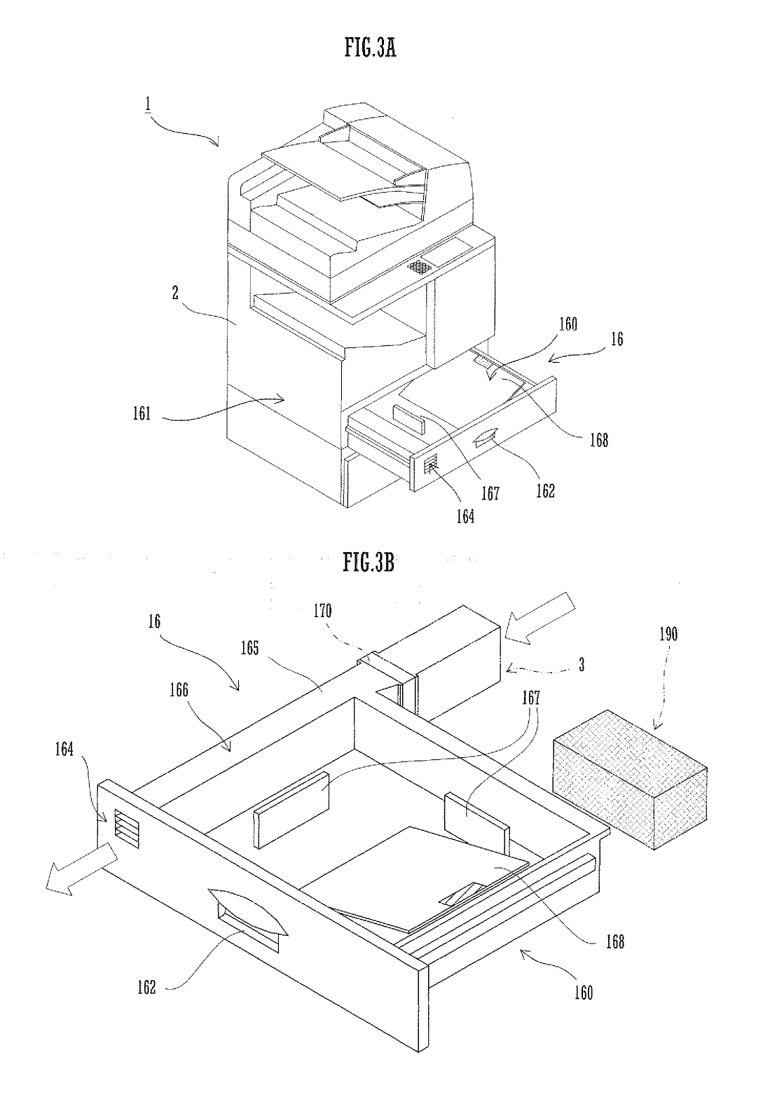

Referring to FIGS. 3A, 32 and 4, the structure of the first sheet feeding device 16 is schematically described. The first sheet feeding device 16 includes a main body 161 formed integrally with the housing 2 of the copier 1, and a sheet tray 160 which can be drawn out toward the front from the main body 161.

The main body 161 is designed to accommodate the sheet tray 160 in a state capable of being drawn out. The sheet tray 160 is designed to store therein recording sheets to be subjected to image formation. Specifically, the sheet tray 160 includes a tray frame 165, a sheet bearing plate 168, and sheet restraining plates 167.

The tray frame 165 is designed to define a sheet storage space for storing recording sheets therein. The tray frame 165 is provided with a pull 162, an air exhaust portion 164, and a second duct portion 166. The second duct portion 166 has a front side designed to communicate with the air exhaust portion 164 and a rear side formed with an opening which is open rearwardly. The second duct portion 166 is designed to communicate with an ion generating unit 3 to be described later when the sheet tray 160 is in the state of being accommodated in the main body 161.

The sheet bearing plate 168 is designed to be capable of bearing recording sheets thereon and has a downstream side in the sheet feeding direction which is lifted up by a non-illustrated lift-up mechanism in feeding recording sheets. The sheet restraining plates 167 are designed to limit the positions of edges of recording sheets on the sheet bearing plate 168.

The ion generating unit 3 is configured to generate positive ions and negative ions in substantially equal amounts by ionizing water vapor contained in the air by corona discharge. In the present embodiment, each positive ion has plural water molecules attracted around a hydrogen ion (H+) and is represented by H+ (H₂O)ₘ where m is a natural number. On the other hand, each negative ion has plural water molecules attracted around an oxygen ion (O₂—) and is represented by O₂—(H₂O)ₙ where n is a natural number. When attached onto the surfaces of bacteria floating around the copier 1, such positive ions or negative ions cause chemical reaction to produce hydrogen peroxide (H₂O₂) or hydroxyl radical (.OH) as active species. Because hydrogen peroxide (H₂O₂) and hydroxyl radical (.OH) exhibit very strong activity, they can kill bacteria floating in the air.

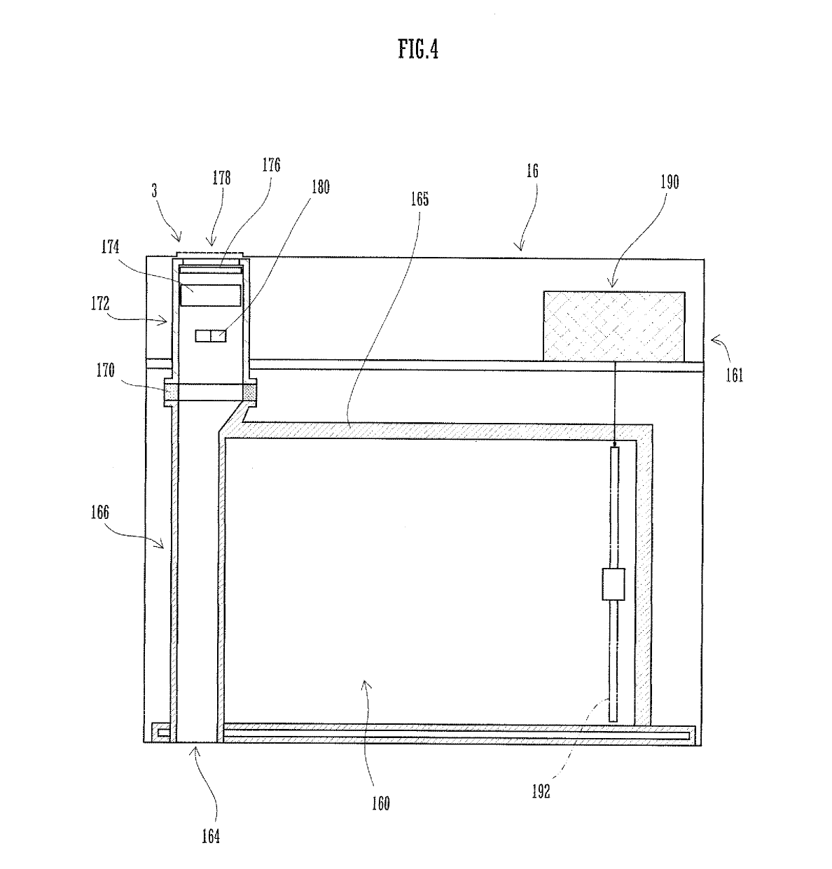

Referring to FIG. 4, the structure of the ion generating unit 3 is schematically described. The ion generating unit 3 is disposed in a free space formed laterally of a driving section 190 on the rear side of the main body 161. The driving section 190 is configured to supply driving power to a feeding mechanism including a pickup roller 192 disposed above the sheet tray 160, the lift-up mechanism for lifting the sheet bearing plate 168, and the like. The feeding mechanism and the lift-up mechanism according to the present embodiment are equivalent to the feeding means defined by the present invention.

As shown in FIG. 4, the ion generating unit 3 includes a first duct portion 172, a filter 176, a fan 174, and an ion generating device 180. The first duct portion 172 has a rear side formed with an opening in communication with an air intake portion formed at the housing 2 and a front side formed with an opening in communication with the second duct portion 166. The first duct portion 172 is designed to define a flow path for guiding air taken therein from the air intake portion 178 to the ion generating device 180.

In this embodiment, a joint portion 170 intervenes between the first duct portion 172 and the second duct portion 166 in order to enhance the air-tightness of the first and second duct portions 172 and 166. The joint portion 170 comprises expanded sponge for example and is fixed to the first duct portion 172 side.

The filter 176 is designed to capture dust which is about to enter the first duct portion 172. Though it is sufficient in principle that the filter 176 has an ordinary function for capturing dust, use of a filter having a silicon adsorbing function is preferable.

The fan 174 is disposed upstream of the ion generating device 180. The fan 174 is designed to generate an air flow inside the first and second duct portions 172 and 166 which passes from the air intake portion 174 toward the air exhaust portion 164 through the joint portion 170.

The ion generating device 180 is configured to generate positive ions and negative ions in substantially equal amounts by ionizing water vapor contained in the air present in the duct 172 by corona discharge. The structure of the ion generating device 180 is not limited to that according to the present embodiment.

In the ion generating unit 3, the fan 174 generates an air flow to guide ions generated by the ion generating device 180 to the air exhaust portion 164 through the first duct portion 172, joint portion 170 and second duct portion 166, thereby exhausting the ions outwardly of the housing 2 through the air exhaust portion. At that time, the first duct portion 172, joint portion 170 and second duct portion 166 guide air taken in from outside the main body 161 to outside the main body again without mixing it with air in the internal space of the housing 2 and, hence, gas produced in the image forming section 10 fails to reach the ion generating portion of the ion generating device 180. For this reason, the ion generating efficiency of the ion generating device 180 is not likely to lower even when the copier 1 has been used over a long time period.

Since the air intake portion 178 in communication with the first duct portion 172 is located on the rear surface of the housing 2 while the exhaust fan 18 for exhausting air from the image forming section 10 is located on the left lateral side of the housing 2, gas exhausted by the exhaust fan 18 can hardly be taken in from the air intake portion 178 of the first duct portion 172.

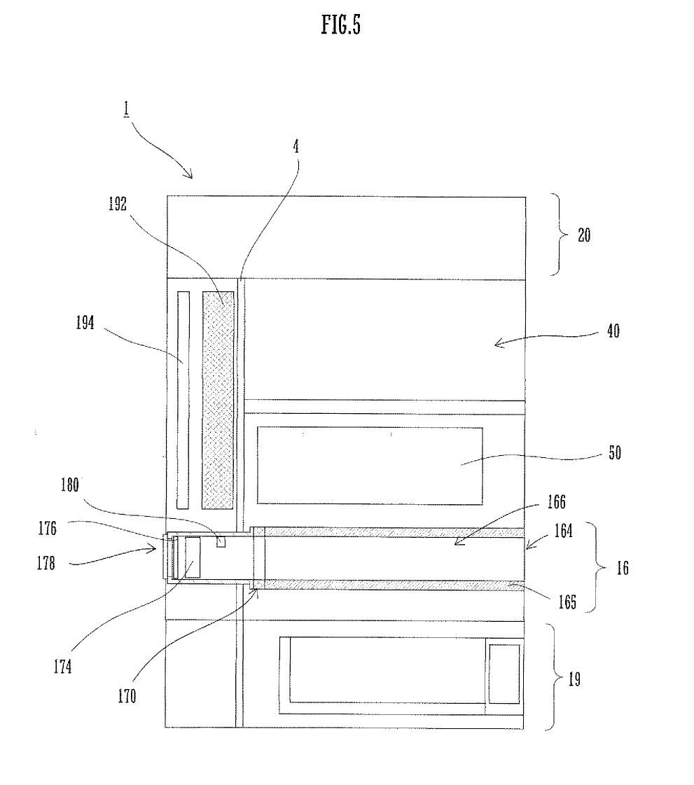

The ion generating unit 3, as well as a driving portion 192 of the image forming section 10 and a control board 194, is disposed by utilizing the space on the rear side of a rear frame 4 as shown in FIG. 5. Therefore, the first sheet feeding device 16 and the copier 1 cannot be increased in size even when the ion generating unit 3 is provided.

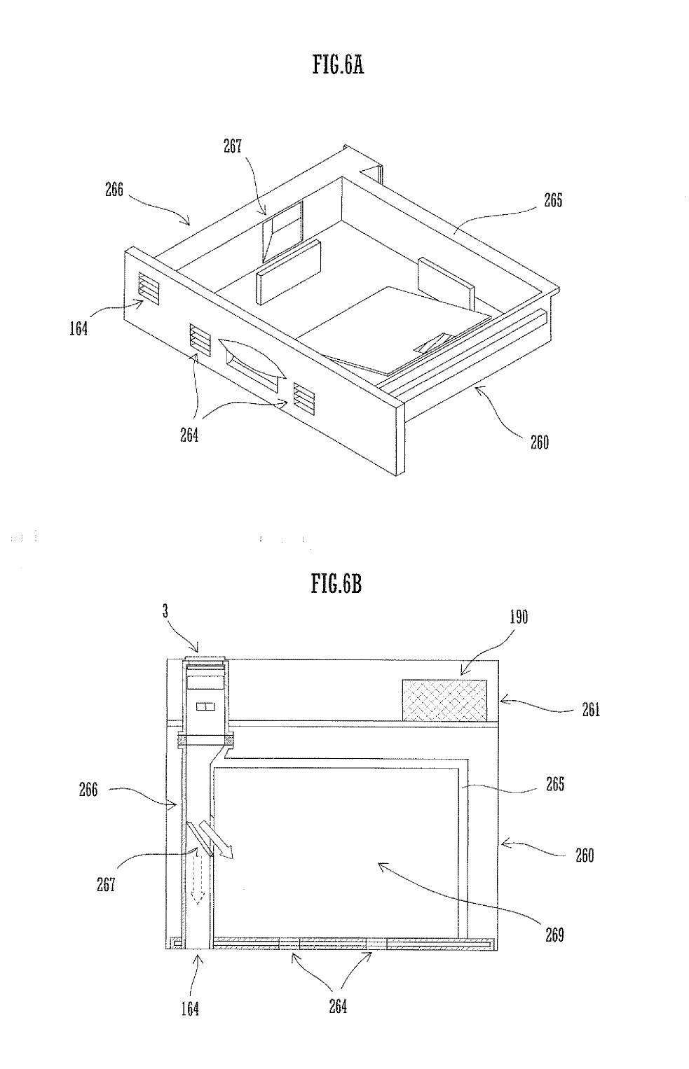

Referring to FIGS. 6A and 6B, schematic description is made of a sheet tray 260 and a main body 261 which form a variation of the first sheet feeding device 16. The sheet tray 260 and the main body 261 are similar in basic structure to the sheet tray 160 and the main body 161 and, hence, description thereof will be omitted.

The sheet tray 260 has a tray frame 265 which is different in structure from the aforementioned tray frame 165.

Specifically, the tray frame 265 has a second duct portion 266 provided with a air flow switching mechanism 267 which is capable of guiding an air flow generated by the fan 174 to the air exhaust portion 164 or a sheet bearing portion 269 of the sheet tray 261 selectively. The air flow switching mechanism 267 comprises, for example, a pivotally supported guide plate forming part of the second duct portion, a switch driving mechanism, such as a motor or a solenoid, for causing the guide plate to pivot, and a control section for controlling the switch driving mechanism. In this case, the tray frame 265 is preferably provided with an air exhaust portion 264 for exhausting air introduced into the sheet bearing portion 269 to the outside. It is possible to employ a control such as to turn off the ion generating device 180 when air is guided into the sheet bearing portion 269.

With the above-described arrangement which can guide air even to the sheet bearing portion 269 when necessary, it is possible to dry recording sheets under an ambience which is likely to moisten the recording sheets, as well as to separate the recording sheets from each other by using an air flow.

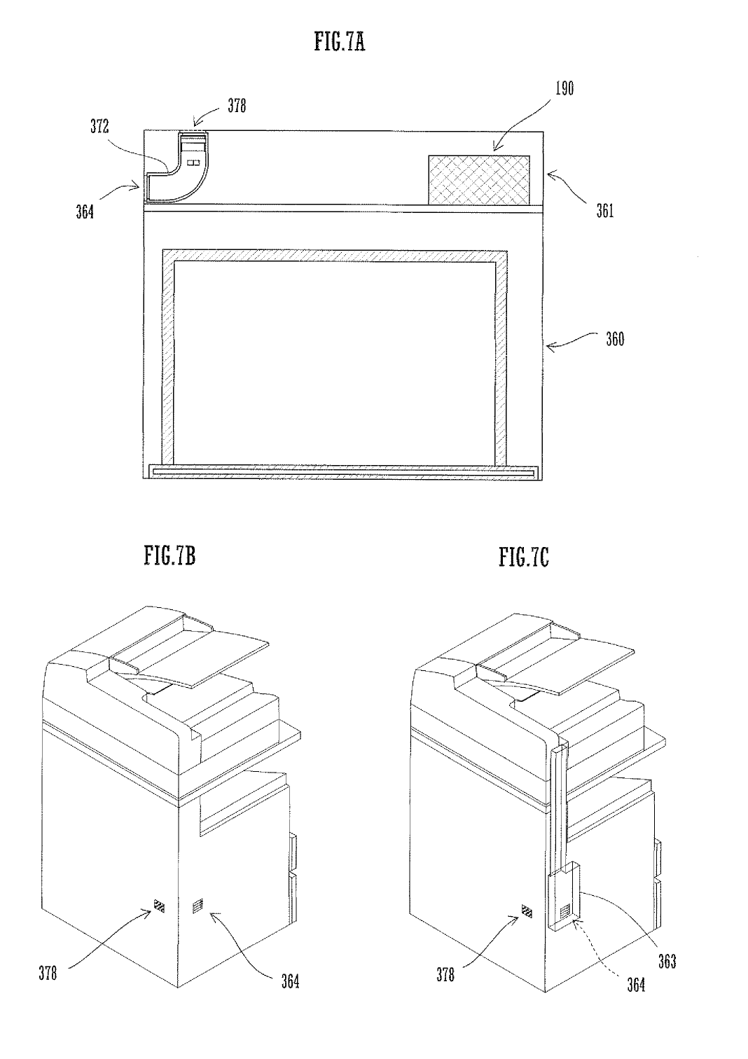

Referring to FIGS. 7A to 7C, schematic description is made of a sheet tray 360 and a main body 361 which form another variation of the first sheet feeding device 16. In this arrangement, an air intake portion 378 is located at a rear surface of the housing 2, while an air exhaust portion 364 is located at a right lateral surface of the housing 2. Further, a first duct portion 372 is substantially L-shaped to communicate with the air intake portion 378 and the air exhaust portion 364. Thus, it is possible to exhaust air taken in from the rear surface to outside the housing 2 without allowing the air to pass through the sheet tray 360.

FIG. 7B illustrates a state in which the copier 1 is not provided with a post-processing device or the like. Even when the copier 1 is provided with the post-processing device, to however, it is possible to diffuse generated ions all around the copier 1 by guiding air, for example, upwardly by utilizing a gap between the housing 2 and the post-processing device.

Alternatively, a guide duct 363 may be additionally provided as shown in FIG. 7C in order to guide air containing generated ions upwardly.

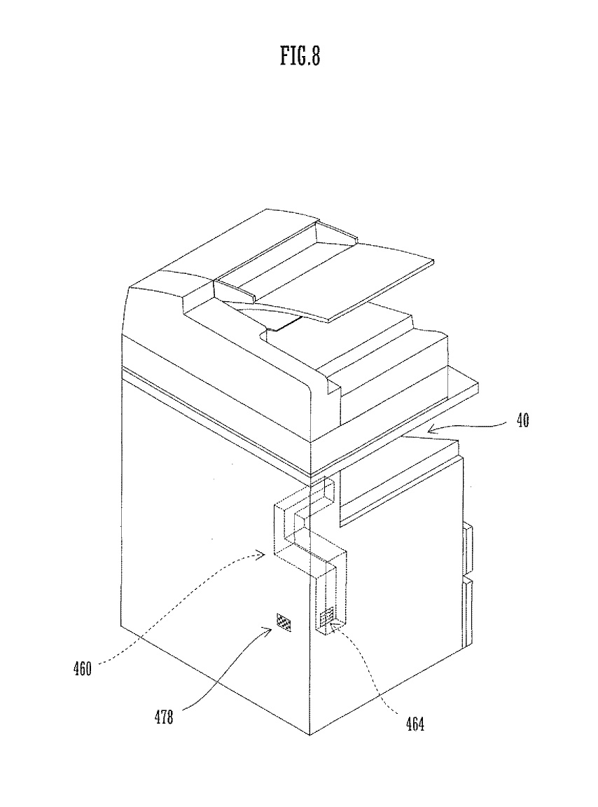

In cases where the copier 1 is provided with the post-processing device, but the gap between the housing 2 and the post-processing device cannot be utilized as an air flow path, a duct 460 may be additionally formed in a space on the rear side of the rear frame 4 as shown in FIG. 8 in order to guide air containing generated ions to the sheet delivery section 40 of the in-body delivery type through the built-in type duct 460.

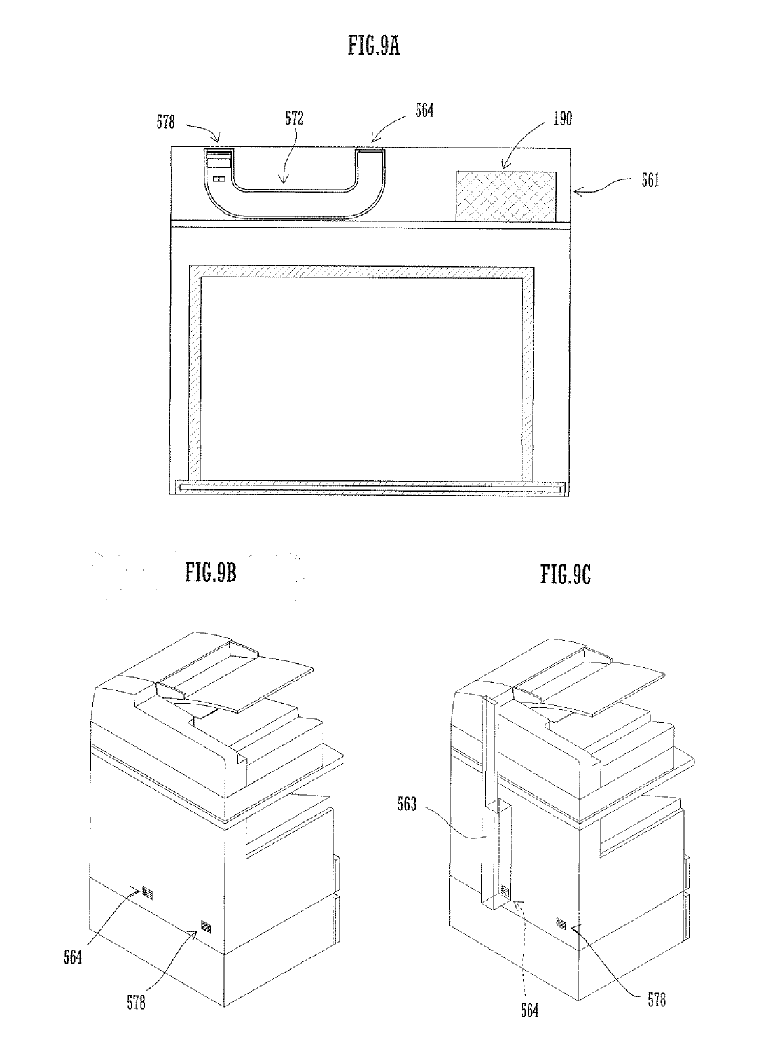

While the description having been made is directed to the exemplary arrangements for taking in air from the rear side and exhausting the air from the front side or the right lateral side or via the sheet delivery section 40, it is possible to employ an arrangement for taking in air from the rear side and exhausting the air to the rear side as shown in FIGS. 9A to 9C. In a main body 561 shown in FIGS. 9A to 9C, an air intake portion 578 and an air exhaust portion 564 are both located at the rear surface of the housing 2, while a U-shaped duct portion 572 is employed for communication with the air intake portion 578 and the air exhaust portion 564.

Further, a guide duct 563 may be additionally provided for guiding ion-containing air exhausted from the rear side upwardly of the copier 1 as shown in FIG. 9C.

Though the first sheet feeding device 16 is imparted with the ion generating function according to the examples having been described above, the second sheet feeding device 19, which is an external device to be optionally mounted on the housing 2, may be provided with an ion generating unit similar to the foregoing ion generating unit.

While the ducts 172 and 65 used in the foregoing embodiments are shaped rectangular in section, use may be made of ducts shaped circular in section or shaped otherwise.

The foregoing embodiments are illustrative in all points and should not be construed to limit the present invention. The scope of the present invention is defined not by the foregoing embodiment but by the following claims. Further, the scope of the present invention is intended to include all modifications within the scopes of the claims and within the meanings and scopes of equivalents.

What is claimed is:

1. A sheet feeding device having an ion generating function, comprising:
a sheet tray for storing recording sheets therein;
a main body designed to accommodate therein the sheet tray in a state capable of being drawn out;
an ion generating device disposed on a rear side of the sheet tray in the main body and having an ion generating function;
a duct portion disposed in such a manner as to cover the ion generating device and designed to define a flow path for guiding air taken therein from outside the main body to outside the main body again; and
a fan designed to generate an air flow within the duct portion.

2. The sheet feeding device according to claim 1, further comprising:
feeding means configured to apply a feeding force onto the recording sheets stored in the sheet tray; and
a driving section disposed on the rear side of the sheet tray in the main body and configured to transmit driving power to the feeding means, wherein
the ion generating device is located laterally of the driving section.

3. The sheet feeding device according to claim 1, wherein the duct portion includes:
a first duct fixed to the main body and having a first end for communication with an air intake portion located at a rear surface of the main body; and
a second duct provided on a frame of the sheet tray and having a first end which communicates with a second end of the first duct when the sheet tray is in a state of being accommodated in the main body and a second end for communication with an air exhaust portion located at a front surface of the main body.

4. The sheet feeding device according to claim 3, wherein the second duct is provided with an air flow switching mechanism which is capable of guiding the air flow generated by the fan one of the air exhaust portion and a sheet bearing portion of the sheet tray selectively.

5. An image forming apparatus comprising:
the sheet feeding device according to claim 1; and
an image forming section configured to carry out an image forming process with respect to a recording sheet fed from the sheet feeding device.

6. The image forming apparatus according to claim 5, wherein an end of the duct portion on the air intake side is located on a rear side of a housing, while an air exhaust portion for the image forming section is located laterally of the housing for exhausting air from the image forming section.
